(19) United States
(12) Patent Application Publication
(10) Pub. No.: US 2020/0408481 A1
(43) Pub. Date: Dec. 31, 2020

(54) ARCHERY DEVICE

(71) Applicant: KO-YU CHANG, TAICHUNG CITY (TW)

(72) Inventor: KO-YU CHANG, TAICHUNG CITY (TW)

(21) Appl. No.: 16/455,996

(22) Filed: Jun. 28, 2019

(51) Int. Cl. F41B 5/12; F41B 5/14

(52) U.S. Cl. CPC F41B 5/123; F16F 1/32; F41B 5/1403

(57) ABSTRACT

An archery device has a body, two limbs, two elastic shooting assemblies, two pulley assemblies, and a string. The two limbs are disposed opposite each other and are capable of swinging relative to the body. Each limb has a free end disposed away from the body. The two elastic shooting assemblies are disposed opposite each other. Each elastic shooting assembly has a guiding unit obliquely extending from the body and toward the front of the body, a joint slidably mounted around the guiding unit, and an elastic unit mounted on and around the guiding unit and simultaneously abutting against the guiding unit and the joint. The two joints of the two elastic shooting assemblies respectively abut against the two limbs. The two pulley assemblies are respectively mounted on the two free ends of the two limbs. The string has two ends respectively fixed to the two pulley assemblies.

### BACKGROUND OF THE INVENTION

### 1. Field of the Invention

The present invention relates to a crossbow, and more particularly to a crossbow that has Belleville springs to prolong the useful life of the crossbow.

### 2. Description of Related Art

With reference to FIG. 9, a conventional crossbow comprises a body 60, a first limb 70A, a second limb 70B, a first pulley assembly 80A, a second pulley assembly 80B, and a string 90. The first limb 70A and the second limb 70B are connected with the body 60. The first pulley assembly 80A is mounted on the first limb 70A and comprises a first pulley 81A and a first cable 82A. The first pulley 81A is mounted rotatably on a free end of the first limb 70A. The first cable 82A is mounted around the first pulley 81A and is connected securely with the second limb 70B. The second pulley assembly 80B is mounted on the second limb 70B and comprises a second pulley 81B and a second cable 82B. The second pulley 81B is mounted rotatably on a free end of the second limb 70B. The second cable 82A is mounted around the second pulley 81B and is connected securely with the first limb 70A. The string 90 is mounted around the first pulley 81A and the second pulley 81B and has two ends connected respectively with the first pulley 81A and the second pulley 81B.

With reference further to FIG. 10, when the string 90 is pulled, the first pulley 81A and the second pulley 81B are driven to rotate by the string 90. The first cable 82A and the second cable 82B are partially rolled around the first pulley 81A and the second pulley 81B, and the free ends of the first and second limbs 70A, 70B are bent toward the body 60. Because the first cable 82A and the second cable 82B are connected securely with the first limb 70A and the second limb 70B respectively, the rolled length of the cables 82, 82B onto the pulleys 781A, 81B will determine the bent degrees of the limbs 70A, 70B. The limbs 70A, 70B may be overly bent in each operation of the crossbow, such that the limbs 70A, 70B easily elastically fatigue. Therefore, the useful life of the crossbow will be shortened.

To overcome the shortcomings of the conventional crossbow, the present invention provides an archery device to mitigate or obviate the aforementioned problems.

### SUMMARY OF THE INVENTION

The main objective of the present invention is to provide an archery device shooting arrows by elasticity to prolong the useful life of the crossbow.

The archery device comprises a body, two limbs, two elastic shooting assemblies, two pulley assemblies, and a string. The two limbs are disposed opposite each other and are capable of swinging relative to the body. Each limb has a free end disposed away from the body. The two elastic shooting assemblies are disposed opposite each other. Each elastic shooting assembly has a guiding unit obliquely extending from the body and toward the front of the body, a joint slidably mounted around the guiding unit, and an elastic unit mounted on and around the guiding unit and simultaneously abutting against the guiding unit and the joint. The two joints of the two elastic shooting assemblies respectively abut against the two limbs. The two pulley assemblies are respectively mounted on the two free ends of the two limbs. The string has two ends respectively fixed to the two pulley assemblies.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an archery device in accordance with the present invention;

FIG. 2 is an enlarged perspective view of an elastic shooting assembly of the archery device in FIG. 1 showing the elastic shooting assembly equipped with Belleville springs;

FIG. 3 is an enlarged cross sectional side view of the archery device in FIG. 1;

FIG. 4 is a top view of the archery device in FIG. 1;

FIG. 5 is an enlarged top view of an elastic shooting assembly of the archery device in FIG. 1;

FIG. 6 is an operational top view of the archery device in FIG. 1;

FIG. 7 is an enlarged top view of an elastic shooting assembly of the archery device in FIG. 1 showing the elastic shooting assembly operating;

FIG. 8 is another enlarged perspective view of the elastic shooting assembly of the archery device in FIG. 1 showing the elastic shooting assembly equipped with flat wire compression spring;

FIG. 9 is a perspective view of a conventional crossbow; and

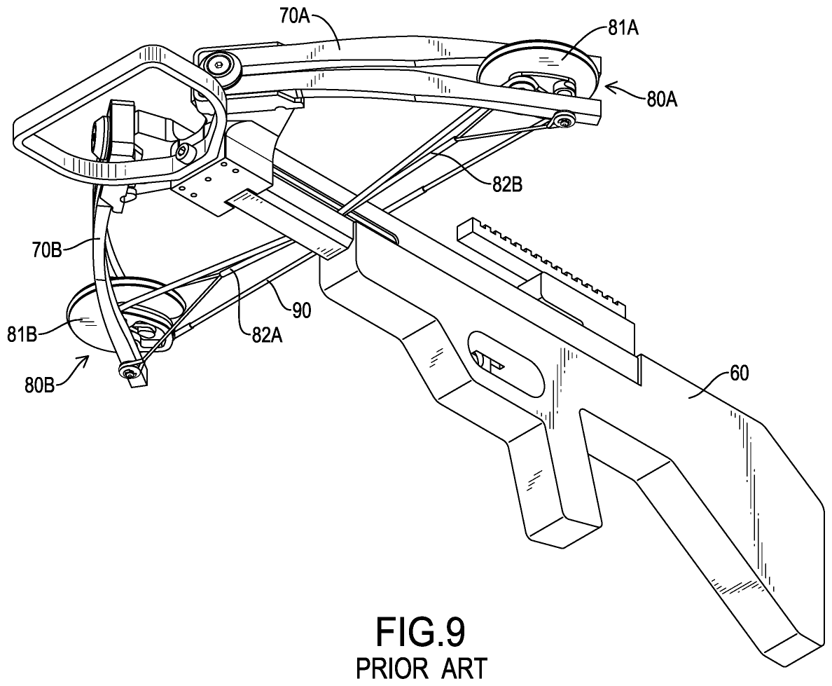

FIG. 10 is an operational bottom view of the conventional crossbow in FIG. 9.

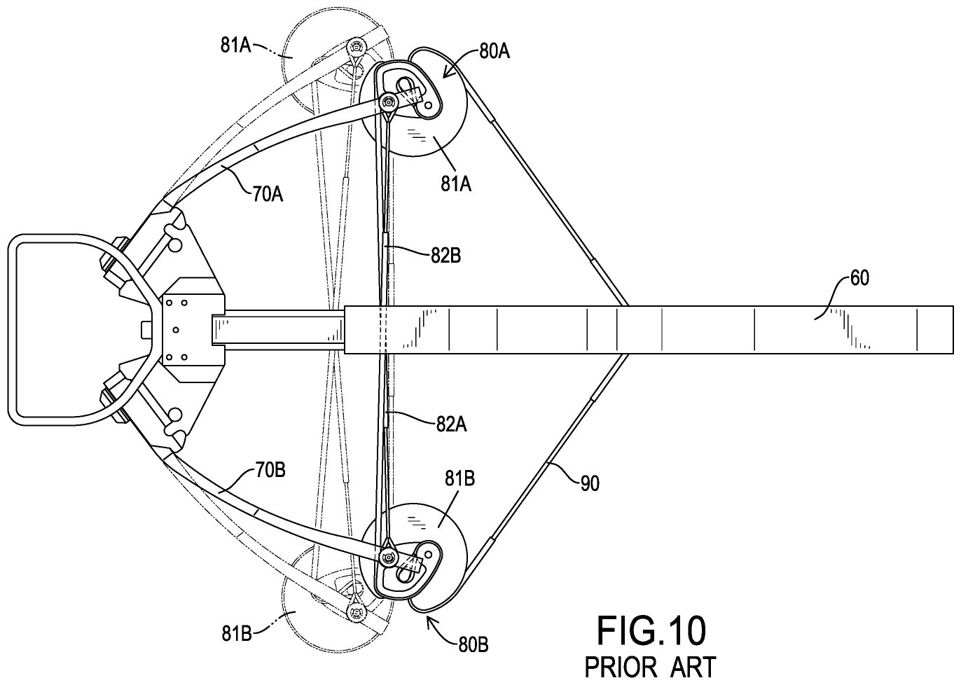

### DETAILED DESCRIPTION OF PREFERRED EMBODIMENTS

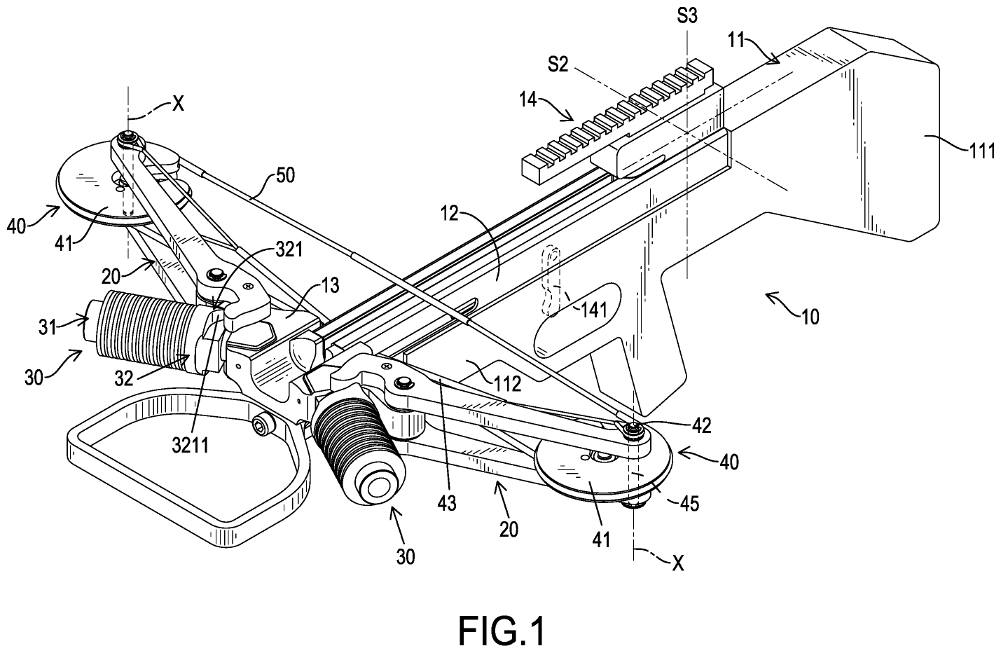

With reference to FIG. 1, an archery device in accordance with the present invention has a body 10, two limbs 20, two elastic shooting assemblies 30, two pulley assemblies 40, and a string 50. The two limbs 20 and the two elastic shooting assemblies 30 are mounted to the body 10. The two pulley assemblies 40 are respectively connected to the two limbs 20. The string 50 is mounted on the two pulley assemblies 40.

With reference to FIGS. 1, 4, and 6, the body 10 has an axis of symmetry S, an extending direction, a lateral direction S2, a longitudinal direction S3, a front end, a rear end, two sides, a holding segment 11, an arrow mount 12, a bow mount 13, and a trigger assembly 14. The extending direction of the body 10 extends along the axis of symmetry S. The extending direction, the lateral direction S2, and the longitudinal direction S3 are perpendicular to one another. The two sides of the body are opposite in the lateral direction S2 of the body 10. The holding segment 11 has a buttstock 111 and a front grip 112. The buttstock 111 is formed on the rear end of the body 10. The front grip 112 is integrally connected with the buttstock 111 and extends along the extending direction of the body 10. The arrow mount 12 is connected to the holding segment 11 for receiving arrows. The arrow mount 12 extends along the extending direction of the body 10 and toward the front end of the body 10. The bow mount 13 is disposed at the front end of the body 10 and is connected to the arrow mount 12. The trigger assembly 14 is connected to the arrow mount 12 and has a trigger 141 mounted through the holding segment 11.

In the embodiment, the buttstock 111 and the front grip 112 of the holding segment 11 are integrally connected with each other, and the holding segment 11 and the arrow mount 12 are two independent components connected to each other. Practically, the buttstock 111 and the front grip 112 may be implemented as two independent components detachably connected to each other or may be formed as an integral component. The combination manner of the holding segment 11, the arrow mount 12, the buttstock 111, and the front grip 112 is not limited in the present invention.

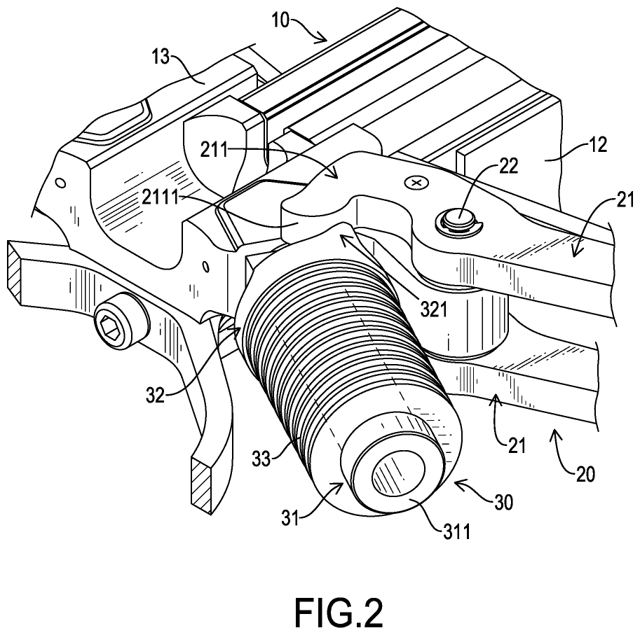

With reference to FIGS. 1 and 2, the two limbs 20 are symmetric with respect to the axis of symmetry S and are respectively disposed at the two sides of the body 10.

The two limbs 20 are rigid components and are hard to be bent. Each limb 20 is connected to the bow mount 13 of the body 10 and is capable of swinging relative to the body 10. Each one of the two limbs 20 has an abutting end and a free end opposite to the abutting end of the limb 20 and disposed away from the body 10. In the embodiment of the present invention, each one of the two limbs 20 has two limb units 21 and a swinging shaft 22. Each limb unit 21 has a pushing protrusion 211. The pushing protrusion 211 is disposed at the abutting end of the limb 20 and has a convex face 2111. The convex face 2111 is a smooth and curved surface. The swinging shaft 22 is mounted through the two limb units 21 of the limb 20 and the bow mount 13 to connect the limb 20 with the bow mount 13. The swing shaft 22 is disposed between the abutting end and the free end of the limb 20 and is disposed adjacent to the abutting end of the limb 20. In the embodiment of the present invention, each one of the two limbs 20 has two limb units 21. Alternatively, each one of the two limbs 20 may be a single component. The configuration of each limb 20 is not limited in the present invention.

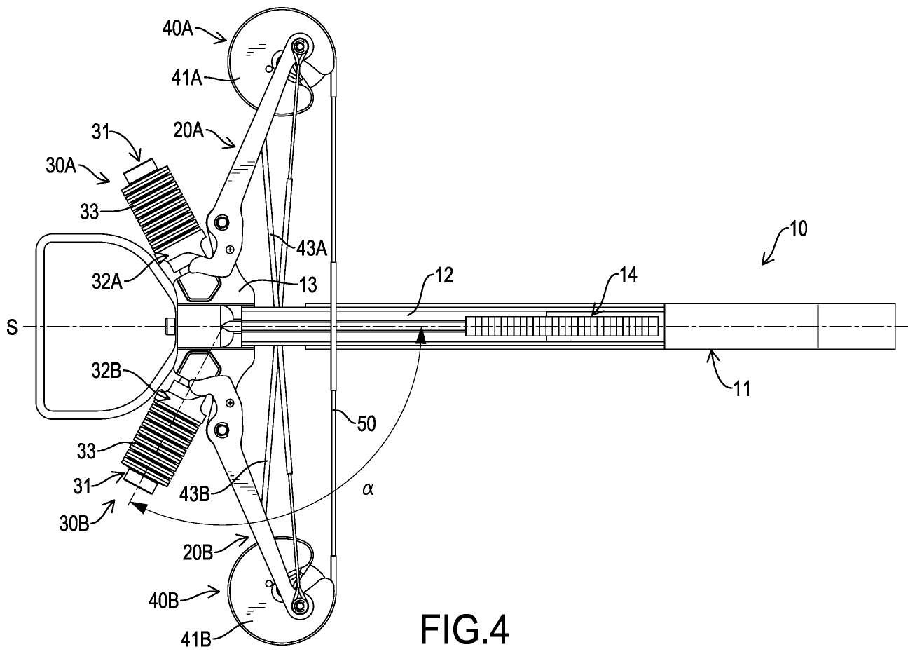

With reference to FIGS. 1 and 4, in the embodiment, the bow mount 13 is disposed at the front end of the body 10. Practically, the bow mount 13 may be disposed at a middle portion of the body 10 or even disposed at a position adjacent to the rear end of the body 10. The position where the bow mount 13 is disposed at the body 10 is not limited in the present invention.

With reference to FIGS. 1 to 3, the two elastic shooting assemblies 30 are symmetric with respect to the axis of symmetry S. Each one of the two elastic shooting assemblies 30 is connected to the bow mount 13 of the body 10 and has a guiding unit 31, a joint 32, an elastic unit 33, and a pin 34. The guiding unit 31 is tubular and has an extending direction, two opposite ends, and a blocking protrusion 311. One of the two opposite ends of the guiding unit 31 is fixed to the bow mount 13 of the body 10. The guiding unit 31 fixed to the bow mount 13 obliquely extends toward the front of the body 10. An angle α is defined between the extending directions of the guiding unit 31 and the body 10. The angle α is larger than 90°. The blocking protrusion 311 is annular and is disposed at the other one of the two opposite ends of the guiding unit 31. The joint 32 is slidably mounted around the guiding unit 31 and has an abutted protrusion 321. The abutted protrusion 321 has a concave face 3211. The concave face 3211 is a smooth and curved surface. The concave face 3211 of the abutted protrusion 321 of the joint 32 of each elastic shooting assembly 30 corresponds to the convex face 2111 of the abutting protrusion 211 of each one of the two limb units 21 of each limb 20 in shape. As long as the two limb units 21 of one of the two limbs 20 abutting against the joint 32 of a corresponding one of the two elastic shooting assemblies 30 capable of smoothly swinging relative to the body 10, the specific shapes of the convex face 2111 and the concave face 3211 are not restricted.

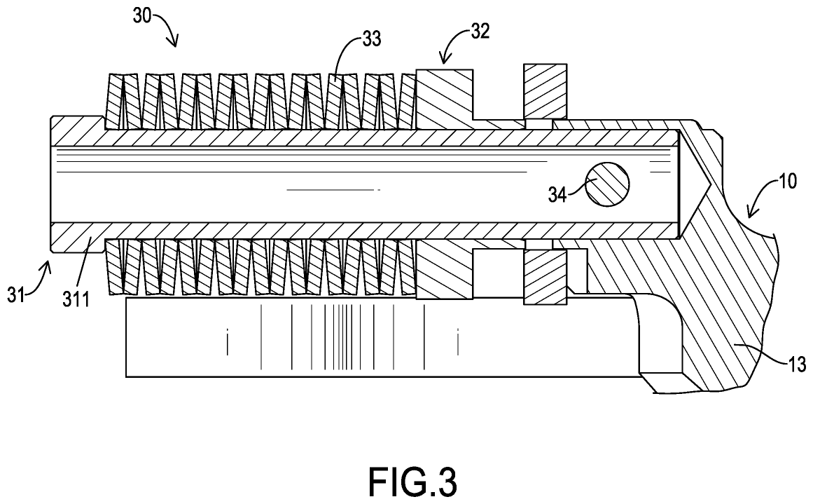

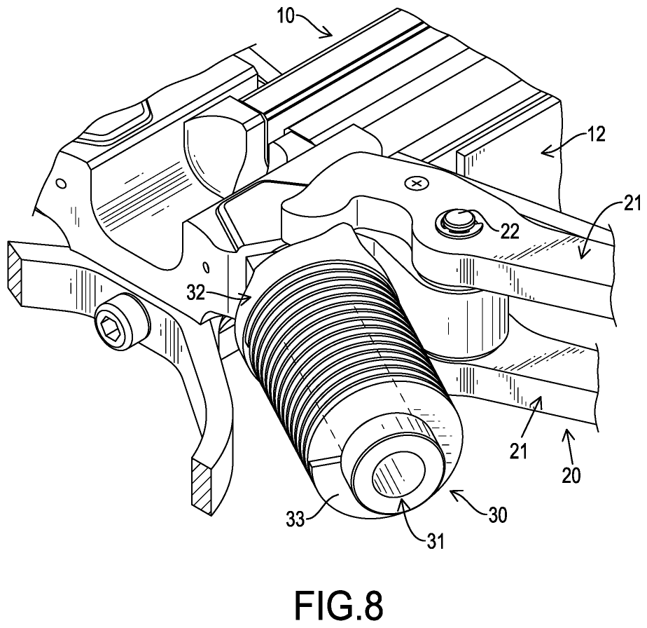

The elastic unit 33 is mounted on and around the guiding unit 31 and abuts against the joint 32 and the blocking protrusion 311 of the guiding unit 31 simultaneously. With reference to FIG. 2, in the embodiment of the present invention, the elastic unit 33 is implemented as multiple Belleville springs. Practically, with reference to FIG. 8, the elastic unit 33 may be implemented as a flat wire compression spring. As long as the elastic unit 33 can be compressed and restores linearly, the configuration of the elastic unit 33 is not restricted in the present invention. With reference to FIG. 3, in the embodiment of the present invention, a pin 34 is mounted through the guiding unit 31 and the bow mount 13 to fix the guiding unit 31 and to connect the guiding unit 31 with the bow mount 13. Alternatively, the guiding unit 31 of each one of the two elastic shooting assemblies 30 may be integrally connected with the bow mount 13 to form an integral component.

Each one of the two guiding units 31 of the two elastic shooting assemblies 30 may be connected to the holding segment 11 as well. As long as the guiding unit 31 of each one of the two guiding units 30 can be mounted on and around by the elastic unit 33 of said shooting assembly 30, the positions and connecting manners of each guiding unit 31 are not restricted. In the embodiment of the present invention, the blocking protrusion 311 of each guiding unit 31 is integrally formed on the guiding unit 31. Practically, the blocking protrusion 311 of each guiding unit 31 may be a bolt screwed with the guiding unit 31.

With reference to FIG. 4, the two limbs 20 are symmetrically disposed along the axis of symmetry S, and the two elastic shooting assemblies 30 are symmetrically disposed along the axis of symmetry S as well. The two joints 32 of the two elastic shooting assemblies 30 are respectively abutted by the two abutting ends of the two limbs 20. The abutted protrusion 321 of each one of the two joints 32 is abutted by the two abutting protrusions 211 of the two limb units 21 of a corresponding one of the two limbs 20. The two convex faces 2111 of the two abutting protrusions 211 abut against the concave face 3211 of the abutted protrusion 321 and are capable of sliding along the concave face 3211.

With reference to FIGS. 1 and 2, the two pulley assemblies 40 are respectively connected at the two free ends of the two limbs 20. Each one of the two pulley assemblies 40 has a string pulley 41, a spinning shaft 42, and a cable 43. The string pulley 41 is an eccentric cam and is rotatably connected to a corresponding one of the two limbs 20. The string pulley 41 is capable of rotating along an axis X parallel to the longitudinal direction S3 of the body 10. In the embodiment, the spinning shaft 42 extends along the axis X and is mounted through the string pulley 41 to make the string pulley 41 connected to the corresponding one limb 20. The cable 43 has two opposite ends. One of the two opposite ends of the cable 43 is fixed to the string pulley 41 of said pulley assembly 40. The other one of the two opposite ends of the cable is fixed to the two limb 20 on which the other pulley assembly 40 is mounted.

With reference to FIG. 1, the string 50 is wound around the two string pulleys 41 of the two pulley assemblies 40 and has two opposite ends. The two opposite ends of the string 50 are respectively fixed to the two string pulleys 41 of the two pulley assemblies 40.

With reference to FIG. 4, for concision of description, the two limbs 20 are distinguished into a first limb 20A and a second limb 20B. The two elastic shooting assemblies 30 are distinguished into a first elastic shooting assembly 30A and a second elastic shooting assembly 30B. The two joints 32 of the first elastic shooting assembly 30A and the second elastic shooting assembly 30B are further distinguished into a first joint 32A and a second joint 32B. The two pulley assemblies 40 are distinguished into a first pulley assembly 40A connected to the first limb 20A and a second pulley assembly 40B connected to the second limb 20B. The first pulley assembly 40A and the second pulley assembly 40B respectively have the string pulley 41A, 41B and the cable 43A, 43B. Wherein, the cable 43A of the first pulley assembly 40A extends around and is fixed to the string pulley 41A of the first pulley assembly 40A. The cable 43A extends toward the free end of the second limb 20 and is fixed to the free end of the second limb 20B. Similarly, the cable 43B of the second pulley assembly 40B extends around and is fixed to the string pulley 41B of the second pulley assembly 40B. The cable 43B extends toward the free end of the first limb 20A and is fixed to the free end of the first limb 20A.

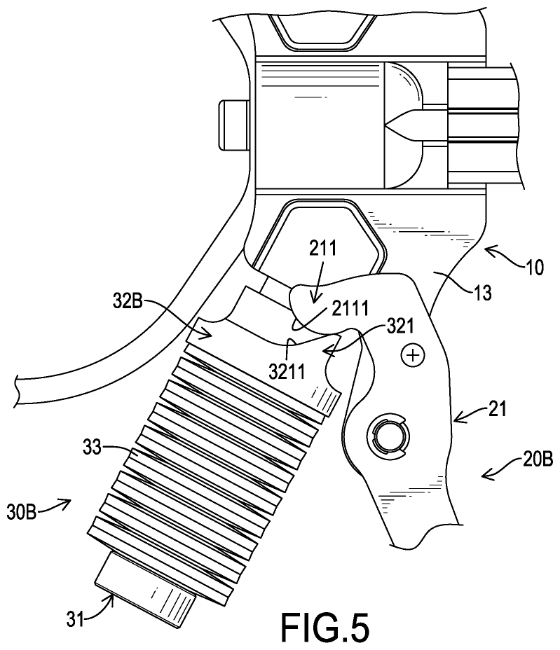

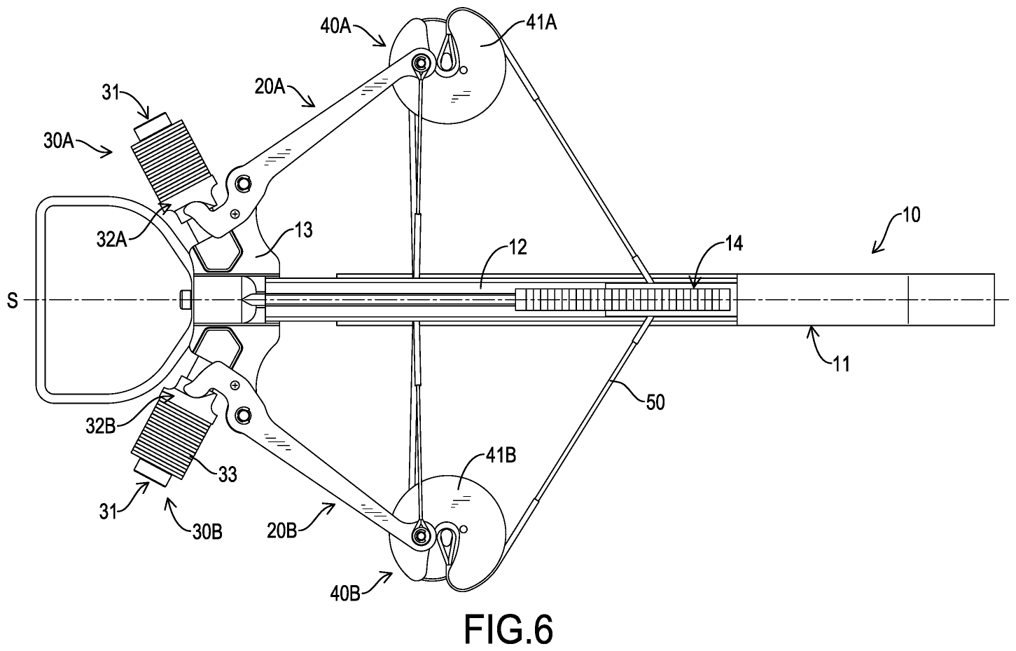

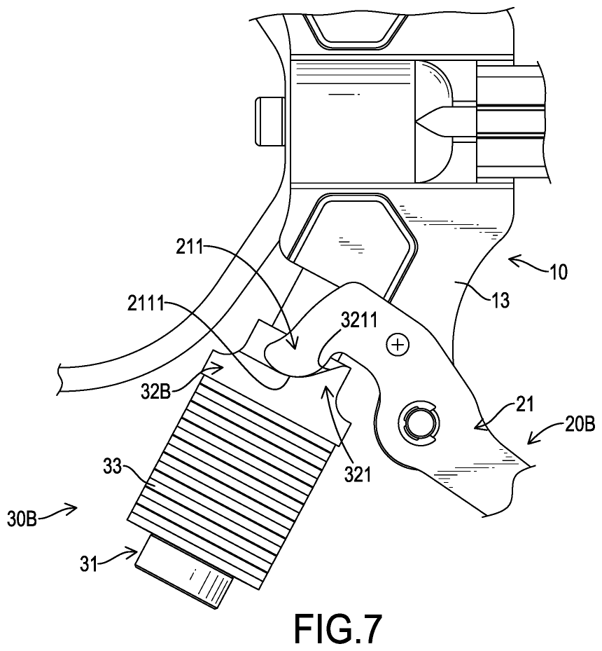

With reference to FIGS. 4 and 6, the string 50 is subjected to a pulling force and is pulled toward the rear end of the body 10. The string 50 that extends around and is fixed to the two string pulleys 41A, 41B drives the two string pulleys 41A, 41B to rotate. The two string pulleys 41A, 41B wind up the two cables 43A, 43B that are respectively fixed to the two string pulleys 41A, 41B. The two cables 43A, 43B respectively pull the two free ends of the first and second limbs 20A, 20B and make the two free ends of the first and second limbs 20A, 20B move toward the body 10. The first second limb 20A, the first elastic shooting assembly 30A and the second limb 20B, the second elastic shooting assembly 30B work in the same manner. For concision of description, only the second limb 20A and the second elastic shooting assembly 30B mounted on the second limb 20B are illustrated here. With reference to FIGS. 5 and 7, when the free end of the second limb 20B is pulled toward the body 10, the abutting end of the second limb 20B abuts against the second joint 32B of the second elastic shooting assembly 30B. The second joint 32B slides along the guiding unit 31 of the second elastic shooting assembly 30B and abuts against the elastic unit 33 of the elastic shooting assembly 30B. The elastic unit 33 that is the multiple Belleville springs is compressed by the second joint 32B. When the sting 50 is released, the elastic unit 33 restores and pushes the second joint 32B to push the second limb 20B for shooting an arrow.

Compared to the conventional cross bow, the first and second limbs 20A, 20B are respectively driven by the two elastic units 33 of the first and the second elastic shooting assemblies 30A, 30B. Therefore, the first and second limbs 20A, 20B are capable of shooting the arrow without bending. Strains of the first and second limbs 20A, 20B are reduced. The useful lives of the first and second limbs 20A, 20B are prolonged. Each elastic unit 33 may be the multiple Belleville springs or a flat wire compression spring. The multiple Belleville springs are durable and are usually applied to sustain heavy loads in the industries. Therefore, the durable Belleville springs also can prolong the useful life of the archery device in accordance with the present invention. Finally, the archery device in accordance with the present invention is not only applicable to a crossbow, but also applicable to a bow.

Moreover, compared to the conventional cross bow that shoots arrow by limbs with elasticity, the pushing protrusion 211 of each limb unit 21 continuously abuts against the joint 32 of the corresponding one of the two elastic shooting assemblies 30. Before the string 50 being pulled toward the rear end of the body 10, the pushing protrusion 211 of the limb unit 21 abuts against the joint 32 already. Therefore, a force providing by the present invention for shooting the arrow smoothly rises to shoot the arrow steadily.

Eventually, the pushing protrusion 211 of each limb unit 21 has the convex face 2111 being a smooth and curved surface, and the abutted protrusion 321 of each joint 32 has the concave face 3211 being a smooth and curved surface. The convex face 2111 corresponds to the concave face 3211 in shape, so the convex face 2111 of the limb unit 21 of each limb 20 slides along the concave face 3211 of the abutted protrusion 321 of the joint 32 of the corresponding one of the two elastic shooting assemblies 30 consequently. Therefore, the force providing by the present invention for shooting the arrow is capable of being gradually changed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An archery device comprising:
a body having a lateral direction and an elongating direction being perpendicular to each other and two sides opposite in the lateral direction of the body;
two limbs respectively disposed at the two sides of the body, capable of swinging relative to the body, and each one of the two limbs having
an abutting end; and
a free end opposite the abutting end of the limb and disposed away from the body;
two elastic shooting assemblies respectively disposed at the two sides of the body, each one of the two elastic shooting assemblies having
a guiding unit obliquely extending from the body and toward the front of the body;
a joint slidably mounted around the guiding unit; and
an elastic unit mounted on and around the guiding unit and simultaneously abutting against the guiding unit and the joint;
the two joints of the two elastic shooting assemblies respectively abutting against the two abutting ends of the two limbs;
two pulley assemblies respectively mounted on the two free ends of the two limbs; and
a string with two ends respectively fixed to the two pulley assemblies.

2. The archery device as claimed in claim 1, wherein
each limb has two limb units;
each limb unit has a pushing protrusion disposed at the abutting end of the limb; and
the joint of each of the elastic shooting assemblies has an abutted protrusion abutted against the two pushing protrusions of the limb unit of the limb that abuts against the joint.

3. The archery device as claimed in claim 2, wherein
the guiding unit of each one of the two elastic shooting assemblies has
two opposite ends, wherein one of the two opposite ends is connected to the body; and
a blocking protrusion disposed at the other one of the two opposite ends of the guiding unit.

4. The archery device as claimed in claim 3, wherein the elastic unit of each one of the two elastic shooting assemblies comprises multiple Belleville springs.

5. The archery device as claimed in claim 3, wherein the elastic unit of each one of the two elastic shooting assemblies comprises a flat wire compression spring.

6. The archery device as claimed in claim 4, wherein
each one of the two pulley assemblies has
a string pulley rotatably mounted on a corresponding one of the two limbs; and
a cable wound around the string pulley and having two ends; and
one of the two ends of the cable of each one of the two pulley assemblies is fixed to a corresponding one of the two limbs, and the other one of the two ends of the cable is fixed to the string pulley of the other one of the two pulley assemblies.

7. The archery device as claimed in claim 5, wherein
each one of the two pulley assemblies has
a string pulley rotatably mounted on a corresponding one of the two limbs; and
a cable wound around the string pulley and having two ends; and
one of the two ends of the cable of each one of the two pulley assemblies is fixed to a corresponding one of the two limbs, and the other one of the two ends of the cable is fixed to the string pulley of the other one of the two pulley assemblies.

8. The archery device as claimed in claim 6, wherein
the body has a bow mount;
each limb is swingably connected to the bow mount;
the guiding unit of each one of the two elastic shooting assemblies is fixed to the bow mount.

9. The archery device as claimed in claim 7, wherein
the body has a bow mount;
each limb is swingably connected to the bow mount;
the guiding unit of each one of the two elastic shooting assemblies is fixed to the bow mount.

10. The archery device as claimed in claim 8, wherein
each one of the two pulley assemblies has a spinning shaft; and
the string pulley of each one of the pulley assemblies is mounted on and around the spinning shaft of the pulley assembly.

11. The archery device as claimed in claim 9, wherein
each limb has a swinging shaft mounted through the two limb units and the bow mount.

12. The archery device as claimed in claim 10, wherein
each limb has a swinging shaft mounted through the two limb units and the bow mount.

13. The archery device as claimed in claim 11, wherein the swinging shaft of each limb is disposed between the abutting end and the free end of the limb and is disposed adjacent to the abutting end of the limb.

14. The archery device as claimed in claim 12, wherein the swinging shaft of each limb is disposed between the abutting end and the free end of the limb and is disposed adjacent to the abutting end of the limb.
